(19) United States
(12) Patent Application Publication
(10) Pub. No.: US 2006/0199721 A1
(43) Pub. Date: Sep. 7, 2006

(54) Glass composition fluorescent at infrared wavelengths

(75) Inventors: Shoichi Kishimoto, Tokyo (JP); Koichi Sakaguchi, Tokyo (JP); Masahiro Tsuda, Tokyo (JP); Shigeki Nakagaki, Tokyo (JP); Shigekazu Yoshii, Tokyo (JP)

Correspondence Address: HAMRE, SCHUMANN, MUELLER & LARSON, P.C., P.O. BOX 2902-0902, MINNEAPOLIS, MN, 55402, US

(73) Assignee: Nippon Sheet Glass Company, Limited, Tokyo (JP)

(21) Appl. No.: 10/540,048

(22) PCT Filed: Dec. 24, 2003
(86) PCT No.: PCT/JP03/16651

§ 371 Date: Jun. 22, 2005

(30) Foreign Application Priority Data
Dec. 25, 2002 (JP) 2002-373469
Jul. 16, 2003 (JP) 2003-197802

(51) Int. Cl. C03B 19/10; C03C 3/072

(52) U.S. Cl. 501/75; 65/17.1

(57) ABSTRACT

The present invention provides a glass composition that exhibits a fluorescence function and an optical amplification function in a wide wavelength range. This glass composition includes a bismuth oxide, an aluminum oxide, and a glass network former. The glass network former includes an oxide other than silicon oxides as its main component. The glass composition emits fluorescence in an infrared wavelength region through irradiation of excitation light, with bismuth contained in the bismuth oxide functioning as a fluorescent source. A preferable glass network former is B₂O₃ or P₂O₅. This glass composition further may contain a univalent or divalent metal oxide.

### TECHNICAL FIELD

The present invention relates to a glass composition that can function as a light emitter or an optical amplification medium.

### BACKGROUND ART

Glass that includes a rare earth element such as Nd, Er, Pr, etc. and emits fluorescence in the infrared region has been known. Laser emission and optical amplification that were achieved using this glass were studied mainly in the 1990s. Fluorescence of this glass is caused by radiative transition of the 4f electron of a rare earth ion. Since the 4f electron is covered with an outer-shell electron, the fluorescence can be obtained only in a narrow wavelength region. This limits the ranges of the wavelengths of light that can be amplified and the wavelengths at which laser oscillation can occur.

With consideration given to this, each of JP11(1999)-317561A and JP2001-213636A discloses a glass composition that includes a large amount (for instance, at least 20 mol %) of Bi₂O₃ as well as Er as a fluorescent element and that allows a wavelength range of 80 nm or longer to be used. However, since the fluorescent source is Er, the extension of the wavelength range is limited to about 100 nm. In addition, the refractive index of the glass composition is as high as about 2. Accordingly, when it is connected to a silica glass optical fiber that is used in optical communications, a problem tends to be caused by reflection at the interface therebetween.

Each of JP6(1994)-296058A, JP2000-53442A, and JP2000-302477A discloses a glass composition that includes Cr or Ni as a fluorescent element and allows fluorescence to occur in a wide wavelength range. In the glass composition including Cr as a fluorescent element, its main component is Al₂O₃ and its glass network former is limited to a small amount (20 mol % or less). Accordingly, this glass composition tends to devitrify when being melted or formed. It is necessary for the glass composition including Ni as a fluorescent element to contain at least one of a Ni⁺ ion, a microcrystal including a Ni²⁺ ion, and a Ni ion having a hexacoordinated structure. In addition, fine particles of Ni deposit. Accordingly, this glass composition also tends to devitrify.

JP11(1999)-29334A discloses a silica glass doped with Bi. In this glass composition, Bi has been clustered in zeolite and thereby fluorescence is obtained over an increased wavelength range. In this silica glass, however, Bi has been clustered and therefore respective Bi elements are extremely close to each other. Hence, deactivation tends to occur between adjacent Bi elements, which results in lower efficiency in optical amplification. Since this silica glass is produced using a sol-gel method, the occurrences of shrinkage during drying and cracks during baking are problems in mass production of large-sized glass or optical fibers.

JP2002-252397A discloses an optical fiber amplifier including Bi₂O₃—Al₂O₃—SiO₂ silica glass. With this, amplification of light in the 1.3-μm range can be carried out using a 0.8-μm-range semiconductor laser as an excitation light source. This amplifier is excellent in compatibility with silica glass optical fibers. It, however, is necessary to melt the silica glass at 1750° C. or higher and it has a deformation point of at least 1000° C. Accordingly, the optical fibers cannot be manufactured readily. Even if manufactured, they have a lower transmittance.

### DISCLOSURE OF THE INVENTION

The present invention is intended to provide a new glass composition that exhibits a fluorescence function and an optical amplification function in the infrared wavelength region, particularly in a wide wavelength range that is used in optical communications.

A glass composition of the present invention includes a bismuth oxide, an aluminum oxide, and a glass network former. The glass network former contains an oxide other than a silicon oxide as its main component. The glass composition emits fluorescence in the infrared wavelength region through irradiation of excitation light, with bismuth contained in the bismuth oxide functioning as a fluorescent source.

In the present specification, the “main component” denotes a component whose content by percentage is the highest.

The present invention can provide a glass composition that emits fluorescence in a wide wavelength range within the infrared region and melts at a lower temperature than that at which a silica glass melts.

### BRIEF DESCRIPTION OF DRAWINGS

FIG. 1 is a diagram showing an example of a light amplifier according to the present invention that was used as an optical system for evaluating optical amplification characteristics.

FIG. 2 is a diagram showing a system for detecting light in the 1100-nm range, which is included in the optical system for evaluating optical amplification characteristics.

FIG. 3 is a diagram showing a system for detecting light in the 1300-nm range, which is included in the optical system for evaluating optical amplification characteristics.

FIG. 4 is a diagram showing another example of a light amplifier according to the present invention that was used as an optical system for evaluating optical amplification characteristics of optical fibers.

FIG. 5 is a graph showing examples of light transmission spectra of glass compositions according to the present invention.

FIG. 6 is a graph showing an example of measurement of the half-height width of the optical absorption peak in a glass composition of the present invention.

FIG. 7 is a graph showing examples of fluorescence spectra obtained in a glass composition of the present invention.

FIG. 8 is a graph showing other examples of light transmission spectra of glass compositions according to the present invention.

FIG. 9 is a graph showing further examples of fluorescence spectra obtained in a glass composition of the present invention.

FIG. 10 is a graph showing an example of optical amplification characteristics of a glass composition according to the present invention.

### BEST MODE FOR CARRYING OUT THE INVENTION

Hereinafter, the unit “%” that is used for indicating a composition denotes “mol %” in every case.

The glass composition of the present invention includes, as essential elements, a bismuth oxide, an aluminum oxide (Al₂O₃), and a glass network former. Al₂O₃ is too poor in glass network forming ability to be classified as the glass network former. A typical glass network former is a silicon oxide. The present invention, however, employs an oxide other than silicon oxide as the main component of the glass network former. This main component is, for instance, a boron oxide (B₂O₃), a phosphorus pentoxide (P₂O₅), a germanium oxide (GeO₂), or a tellurium dioxide (TeO₂), preferably B₂O₃ or P₂O₅. This glass composition can have a deformation point of 750° C. or lower.

Preferably, the glass composition of the present invention has an optical absorption peak in the wavelength range of 400 nm to 900 nm, preferably 400 nm to 850 nm. It is advantageous that the optical absorption peak appears in at least one selected from the wavelength range of 400 nm to 550 nm and the wavelength range of 650 nm to 750 nm, preferably in both the wavelength ranges. The optical absorption peak may appear in the wavelength range of 750 nm to 900 nm.

The wavelength at which the maximum intensity of the fluorescence that is emitted when the glass composition of the present invention is irradiated with excitation light having a wavelength in a range of 400 nm to 900 nm is obtained is in the range of, for instance, 900 nm to 1600 nm, preferably 1000 nm to 1600 nm, and more preferably 1000 nm to 1400 nm. The present invention allows the half-height width with respect to the wavelength of that fluorescence to increase to at least 150 nm, for instance, to 150 nm to 400 nm. At least the fact that the fluorescent source is a positive ion of bismuth contributes to this increase in the half-height width. The glass composition of the present invention also can be used as an optical amplification medium that provides an amplification gain in at least a part of the wavelength range of 900 nm to 1600 nm through irradiation of excitation light.

Preferably, the glass composition of the present invention further includes a univalent or divalent metal oxide. This oxide facilitates vitrification. A suitable divalent metal oxide is at least one selected from MgO, CaO, SrO, BaO, and ZnO. A suitable univalent metal oxide is at least one selected from Li₂O, Na₂O, and K₂O. MgO and Li₂O are preferable components. It therefore is preferable that the glass composition include at least one of the two oxides. A suitable content by percentage of the univalent or divalent metal oxide is 3% to 40%.

In the glass composition of the present invention, it is preferable that the content by percentage of bismuth oxide be in the range of 0.01% to 15%, particularly 0.01% to 5%, in terms of Bi₂O₃. Preferably, the content by percentage of aluminum oxide is 5% to 30%. It also is preferable that the content by percentage of the main component of the glass network former be 30% to 90%.

Preferable compositions of the glass composition of the present invention are described below as examples.

A first example is a composition including B₂O₃ as the main component of the glass network former. This composition includes the following components: 30% to 90% B₂O₃; 5% to 30% Al₂O₃; 0% to 30% Li₂O; 0% to 15% Na₂O; 0% to 5% K₂O; 0% to 40% MgO; 0% to 30% CaO; 0% to 5% SrO; 0% to 5% BaO; 0% to 25% ZnO; 0% to 10% TiO₂; and 0% to 5% ZrO₂, wherein the total of MgO+CaO+SrO+BaO+ZnO+Li₂O+Na₂O+K₂O is in the range of 3% to 40%, and the content by percentage of bismuth oxide is 0.01% to 15% in terms of Bi₂O₃.

A second example is a composition including P₂O₅ as the main component of the glass network former. This composition includes the following components: 50% to 80% P₂O₅; 5% to 30% Al₂O₃; 0% to 30% Li₂O; 0% to 15% Na₂O; 0% to 5% K₂O; 0% to 40% MgO; 0% to 30% CaO; 0% to 15% SrO; 0% to 15% BaO; 0% to 15% ZnO; 0% to 10% TiO₂; 0% to 5% ZrO₂; and 0% to 20% SiO₂, wherein the total of MgO+CaO+SrO+BaO+ZnO+Li₂O+Na₂O+K₂O is in the range of 3% to 40%, and the content by percentage of bismuth oxide is 0.01% to 15% in terms of Bi₂O₃. In this example, it is more preferable that the contents by percentage of SrO and BaO each be 0% to 5%.

An increase in the ratio of salts, for instance, carbonate and ammonium salt that are contained in the raw material of the glass composition may cause the raw material to bubble intensely during melting. The occurrence of intense bubbling is not preferable in terms of transparency of glass. Ammonium salt often is contained in the raw material of the glass composition that contains P₂O₅ as the main component of the glass network former. In this raw material, the ratio of ammonium salt is higher. In this case, it is particularly preferable that the raw material be melted after the ammonium salt is decomposed.

As described above, it is preferable that a glass composition of the present invention be manufactured by a manufacturing method that includes a melting process in which a raw material of the glass composition is melted and a process for cooling the raw material that has been melted, and the method further include, before the melting process, a heat treatment process in which a first material that contains ammonium salt and that is at least a part of the raw material is maintained at a temperature at which at least the ammonium salt decomposes.

Examples of phosphorus-containing ammonium salt to be used as the raw material of P₂O₅ include ammonium phosphate, diammonium hydrogen phosphate, and ammonium dihydrogen phosphate. The above-mentioned first material may contain other salts, for instance, carbonate in addition to the ammonium salt. Since raw materials that are oxides are not required to be heat-treated, they may be prepared as a second material separate from the first material. In the heat treatment process, it is preferable that the material containing the ammonium salt be heat-treated at a temperature of at least 300° C., for instance 500° C. to 1100° C., for a sufficient period for decomposing the ammonium salt. The heating temperature to be employed in the melting process is at least the treatment temperature that is employed in the heat treatment process, for instance, 1250° C. to 1500° C.

When bismuth is reduced due to the decomposition of the ammonium salt, the fluorescence function of the glass composition deteriorates. It therefore is advantageous that the raw material of bismuth oxide is included in the second material that is prepared separate from the first material. Preferably, the above-mentioned manufacturing method further includes, after the heat treatment process but before the melting process, a process of mixing the first material with a second material that includes a raw material of bismuth oxide or a bismuth oxide itself.

In order to prevent bismuth from being reduced, sulfate or nitrate may be contained as a part of the raw material of glass. Preferably, the raw material of bismuth oxide or the bismuth oxide is allowed to melt together with at least one selected from sulfate and nitrate.

The following description is directed to methods of evaluating characteristics of glass compositions according to specific embodiments of the present invention.

Light Transmission Spectrum

A glass sample was cut out and then was polished to have mirror-finished surfaces and to be a flat sheet with a size of 20 mm×30 mm×3 mm (thickness) whose respective opposing surfaces were in parallel with each other. Thus a sheet sample was produced. The light transmission spectrum of this sheet sample was measured in the wavelength range of 290 nm to 2500 nm using a commercial spectrophotometer. It also was checked whether the optical absorption peak appeared in the respective wavelength ranges of 400 nm to 550 nm and 650 nm to 750 nm in the light transmission spectrum.

The half-height width of an optical absorption spectrum was determined as follows. First, the light transmission spectrum was converted into the molar optical absorption coefficient (that is, with the bismuth oxide indicated in terms of Bi₂O₃, the light transmission spectrum was converted into the optical absorption coefficient that was obtained when 1% of Bi₂O₃ is contained and the optical path has a length of 1 cm). Thus an optical absorption spectrum was prepared. A common tangent to tails of both sides of the peak of this optical absorption spectrum was drawn, which was used as a base line. A top line then was drawn so as to be in parallel with the base line and tangential to the peak. Further, a middle line was drawn that equally divided the distance between the top line and the base line and that was in parallel with those lines. The difference in wavelength between two intersections of the middle line and the spectrum was taken as the half-height width.

Preferably, the light transmission spectrum has an optical absorption peak at which the difference between the top line and the base line is at least 0.01 cm⁻¹mol⁻¹, in the predetermined wavelength range.

Fluorescence Spectrum

With a sheet sample identical to that used in the above, the fluorescence spectrum was measured with a commercial fluorescence spectrophotometer. With respect to each excitation light having a predetermined wavelength, the measurement was carried out in the fluorescence wavelength range of 800 nm to 1600 nm. The sample had a temperature equal to room temperature during the measurement.

The following were determined: the wavelength at which the fluorescence peak appeared in the fluorescence spectrum measured above; the wavelength range (a half-height width of fluorescence) in which the emission intensity was at least half the peak value; and the emission intensity at the wavelength at which the fluorescence peak appeared. The emission intensity is indicated with an arbitrary unit. However, since the sample shape and the position where the sample is placed during the measurement are not changed, a comparison in emission intensity can be made. The half-height width of fluorescence was determined by the same method as that used for determining the half-height width of the optical absorption peak.

Lifetime of Fluorescence

With a sheet sample identical to that used above, the lifetime of fluorescence also was measured with a fluorescence spectrophotometer. The fluorescence decay caused with the passage of time through excitation carried out with pulsed light having a predetermined wavelength was measured. This measurement was carried out at a predetermined wavelength according to the excitation wavelength, for instance at 1140 nm when the excitation wavelength was 500 nm. A decay curve thus obtained was subjected to exponential fitting and thus the lifetime of fluorescence was determined.

Optical Amplification Characteristics

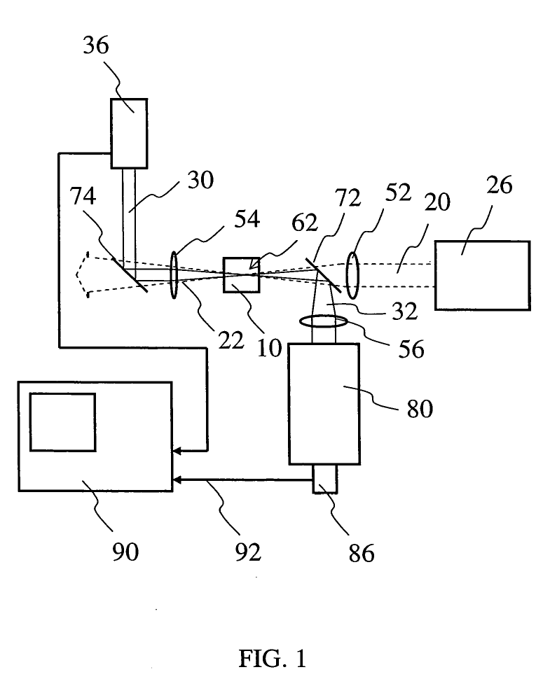

The optical amplification characteristics were determined using the measuring apparatus shown in FIG. 1. The wavelength of excitation light to serve as an energy source for amplifying light was 532 nm while two wavelengths of 1064 nm and 1314 nm were employed as the wavelength of signal light to be amplified. In this apparatus, the excitation light and the signal light are superposed spatially on each other in the glass sample and thereby the signal light transmitted through the glass sample is amplified.

A Nd-YAG green laser to be excited with a semiconductor laser (LD) was used for a light source 26 of excitation light 20 with a wavelength of 532 nm and continuous light emitted therefrom was used as the excitation light 20. The excitation light 20 was focused through a convex lens 52 whose focal length was 300 mm. The position of the lens 52 was adjusted, for example, so that the focal point 62 falls on the midpoint of a glass sample 10 in the direction of its thickness.

On the other hand, when signal light 30 with a wavelength of 1064 nm was used, a Nd-YAG laser to be excited with a semiconductor laser 36 other than the excitation light source 26 was employed as a light source and the signal light 30 was pulsed light with a pulse width ns. When the signal light 30 with a wavelength of 1314 nm was used, it was continuous light emitted from a semiconductor laser 36 with that wavelength. The signal light 30 was allowed to enter the glass sample 10 from the direction opposite to that from which the excitation light 20 entered it. The signal light 30 was focused through a convex lens 54 whose focal length was 500 mm or 1000 mm. The position of the lens 54 was adjusted so that the focal point 62 falls on the midpoint of the glass sample 10 in the direction of its thickness. The combination of the focal length of the lens 52 and that of the lens 54 was selected so that the area through which the signal light beam passed was included well in the area through which the excitation light beam passed.

The signal light 30 and the excitation light 20 were multiplexed/demultiplexed with wavelength selection reflectors 72 and 74. These reflectors 72 and 74 were configured so as to transmit the excitation light 20 but reflect the signal light 30.

When the wavelength of the signal light was 1064 nm, a common transparent glass sheet was used as the reflector for the signal light. A transparent glass sheet causes a reflection of several % at its surface. The signal light 30 with a wavelength of 1064 nm emitted from the light source (Nd-YAG laser) 36 is reflected partly by the reflector 74 and the rest enters the glass sample 10. The signal light 32 that has passed through it, i.e. the signal light 32 that has been amplified, is reflected partly by the reflector 72 to be led to a photodetection system 80 through a lens 56.

The two reflectors 72 and 74 do not have high reflectance with respect to light with a wavelength of 1064 nm. The signal light 30, however, is pulsed light and therefore has a very large peak value (a megawatt level at the point from which a laser is emitted). Accordingly, the measurement thereof is easy. The excitation light 20 passes through the reflector 72 with almost no loss to reach the glass sample 10. The excitation light 22 that has not contributed to the optical amplification in the glass sample reaches the reflector 74. However, since a small quantity of light is reflected by that reflector, no harmful effect is imposed on the signal light source 36.

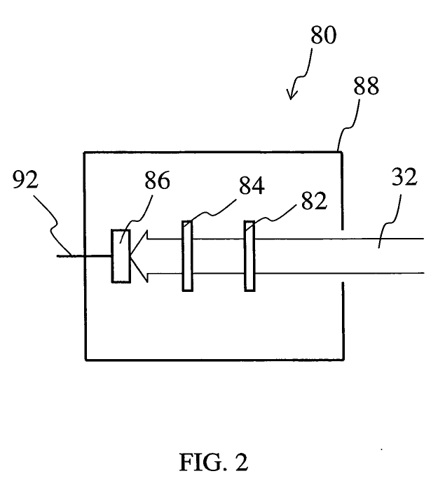

The photodetection system 80 that is used when the signal light has a wavelength of 1064 nm is shown in detail in FIG. 2. The signal light 32 led to the photodetection system 80 covered with a shielding cover 88 passes through a visible-light cut-off filter 82 and then passes through an interference filter 84 that allows only light with a wavelength of 1064 nm to transmit therethrough to remove light components other than the signal light component. The signal light is converted in a photodetector 86 into an electric signal that corresponds to the light signal intensity and then is displayed on an oscilloscope 90 through a signal cable 92. The photodetector 86 to be used herein may be, for instance, a Si based photodiode.

When the signal light with a wavelength of 1314 nm was used, dielectric multilayer mirrors with a high reflectance with respect to the wavelength 1314 nm were used as the reflectors 72 and 74. The signal light 30 emitted from the signal light source (LD) 36 with a wavelength of 1314 nm is reflected by the reflector 74 to enter the glass sample 10. The signal light 32 that has been amplified is reflected by the reflector 72 to be led to the photodetection system 80. The excitation light 20 passes through the reflector 72 with almost no losses to reach the glass sample 10. The excitation light 22 that has not contributed to the optical amplification reaches the reflector 74 to be reflected slightly. In order to prevent that reflected light from entering the signal light source 36, a dielectric multilayer mirror (not shown in the figure) was inserted that was configured to have a high reflectance with respect to a wavelength of 532 nm.

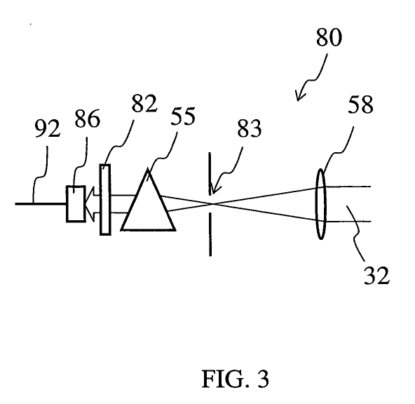

The photodetection system 80 to be employed when the signal light has a wavelength of 1314 nm is shown in detail in FIG. 3. The signal light 32 led to the photodetection system 80 is focused on a point near a pinhole 83 through a lens 58 having a long focal length (for instance, 1000 mm). When the signal light 32 is allowed to pass through the pinhole, its components that travel in directions other than that in which the signal light should travel, i.e. amplified spontaneous emission (ASE) light and scattered light components can be removed. Furthermore, when the signal light 32 is allowed to pass through a prism 55, an excitation light component with a wavelength of 532 nm is removed and thereby the signal light component alone enters the photodetector 86. The light signal is converted into an electric signal that corresponds thereto and then is displayed on the oscilloscope through the signal cable 92. The photodetector 86 to be used herein can be, for instance, a Ge photodiode.

In the optical system shown in FIG. 1, the excitation light 20 and the signal light 30 travel in the directions opposite to each other. However, the directions in which they travel are not limited thereto. For instance, both the lights may travel in the same direction. The glass sample may be of not a block-like shape but a fiber-like shape.

The optical amplification carried out using the above-mentioned optical system was measured as follows.

A glass sample 10 was polished to have mirror-finished surfaces that were in parallel with each other. Thus a block sample was produced. The thickness of the glass sample was determined so that the glass sample had a transmittance of about 95% with respect to the wavelength of excitation light, for instance, a wavelength of 523 nm. This glass sample was set in the position shown in FIG. 1 and some adjustments were made so as to allow the signal light 30 and the excitation light 20 to be superposed well on each other inside the glass sample 10.

Thereafter, the glass sample 10 was irradiated with the signal light 30 and then the intensity of the signal light 32 that had passed through the glass sample 10 was measured with the oscilloscope 90. Subsequently, the glass sample 10 was irradiated with the excitation light 20 while the irradiation of the signal light 30 was continued, and then the intensity of the signal light 32 was measured with the oscilloscope 90 in the same manner as above. The optical amplification phenomenon can be checked through a comparison that is made between the intensity of the signal light transmitted during the irradiation of the signal light alone and that of the signal light transmitted during the simultaneous irradiation of the signal light and the excitation light.

Optical Fiber Amplification Test

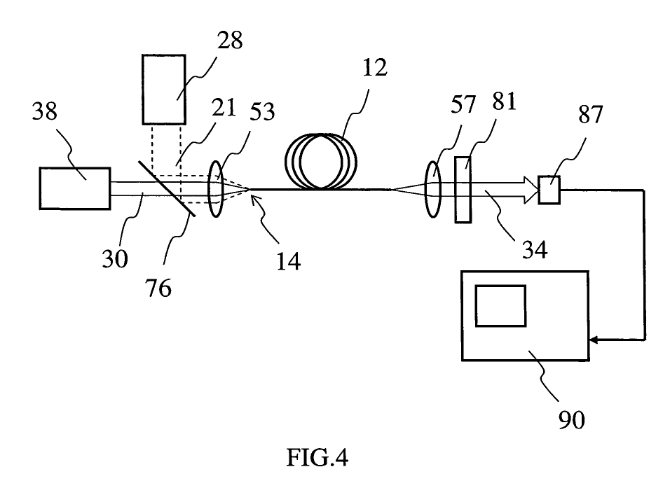

The optical amplification characteristics of an optical fiber sample were determined using the measuring apparatus shown in FIG. 4. The wavelength of excitation light 21 to serve as an energy source for amplifying light was 808 nm while the wavelength of signal light 30 to be amplified was 1314 nm. In this apparatus, the excitation light 21 and the signal light 30 are superposed spatially on each other in the vicinity of an optical fiber end 14 that is a part from which light enters the core of the fiber sample. Thus the signal light 34 that has passed through the fiber sample 12 is amplified.

Continuous light emitted from a semiconductor laser was used for each of light sources 28 and 38 for the excitation light with a wavelength of 808 nm and the signal light with a wavelength of 1314 nm.

The signal light and the excitation light were multiplexed/demultiplexed using a wavelength selection reflector 76. This reflector 76 was configured so as to transmit the signal light 30 but reflect the excitation light 21.

The light that had come out from the optical fiber 12 was led to a photodetector 87 through a lens 57. A filter 81 that transmitted the signal light but intercepted the excitation light was inserted in a place on the optical path. This allowed only the signal light to be detected by the photodetector.

In the optical system shown in FIG. 4, the excitation light and the signal light travel in the same direction, which however is not limited thereto. For instance, they may travel in the directions opposite to each other. The wavelength selection reflector may reflect the signal light but transmit the excitation light. Furthermore, the signal light and the excitation light may be allowed to enter the optical fiber with a means other than the reflector.

The optical amplification carried out using the above-mentioned optical system was measured as follows. The optical fiber sample was cut out to have sections that were specular surfaces. This was set in the above-mentioned measuring apparatus. Some adjustments then were made so as to allow the signal light and the excitation light to enter the core of the optical fiber well.

Thereafter, the end 14 of the optical fiber sample 12 was irradiated with the signal light 30 and then the intensity of the signal light 34 that had passed through the optical fiber sample 12 was measured with the oscilloscope 90. Subsequently, the optical fiber sample 12 was irradiated with the excitation light 21 while the irradiation of the signal light 30 was continued, and then the intensity of the signal light 34 was measured with the oscilloscope 90. The optical amplification phenomenon can be checked through a comparison that is made between the intensity of the signal light transmitted during the irradiation of the signal light alone and that of the signal light transmitted during the simultaneous irradiation of the signal light and the excitation light.

The apparatuses shown in FIGS. 1 and 4, particularly the apparatus shown in FIG. 4, are an example of evaluation apparatus as well as a configuration example of a light amplifier according to the present invention. As shown in the figures, the light amplifier includes light sources of excitation light and signal light in addition to a glass composition of the present invention. The configuration of the light amplifier is not limited to those shown in the figures. For instance, a signal-input optical fiber and a signal-output optical fiber may be disposed instead of the light source of the signal light and the photodetector, respectively. In addition, the excitation light and the signal light may be multiplexed/demultiplexed using a fiber coupler. The use of such a light amplifier makes it possible to carry out a signal light amplification method in which excitation light and signal light are allowed to enter a glass composition of the present invention and thereby the signal light is amplified.

Hereinafter, the present invention is described further in detail using examples and comparative examples.

### EXAMPLE 1

### Borate Glass

Commercially available boron oxide, alumina, lithium carbonate, sodium carbonate, potassium carbonate, magnesium oxide, calcium carbonate, strontium carbonate, barium carbonate, titania, zirconia, zinc oxide, bismuth trioxide (Bi₂O₃), etc were weighed so that the respective compositions indicated in Table 1 were obtained. Thus raw material batches were prepared.

For the purposes of preventing bismuth trioxide from being reduced unnecessarily and refining glass, magnesium sulfate (MgSO₄) that was a commercially available reagent was used as a part of the MgO raw material. In the composition containing Na₂O, sodium sulfate (Glauber's salt, Na₂SO₄) was used as a part of the Na₂O raw material. The content of such sulfates was determined so that the mole ratio thereof to bismuth trioxide was at least 1/20.

Each batch thus prepared was put into an alumina crucible and was kept in an electric furnace at 1400° C. for four hours. Thereafter, the molten batch was poured on an iron plate to be cooled. The glass melt that had been poured thereon was solidified in about ten seconds. After this glass was kept in an electric furnace at 500° C. for 30 minutes, the power of the furnace was turned off and the glass then was cooled slowly to room temperature. Thus, respective glass samples (Samples 11 to 18) were obtained.

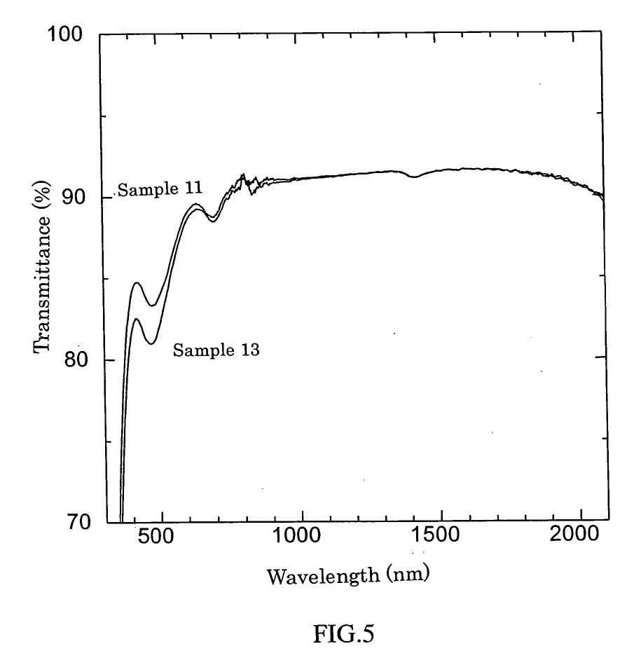

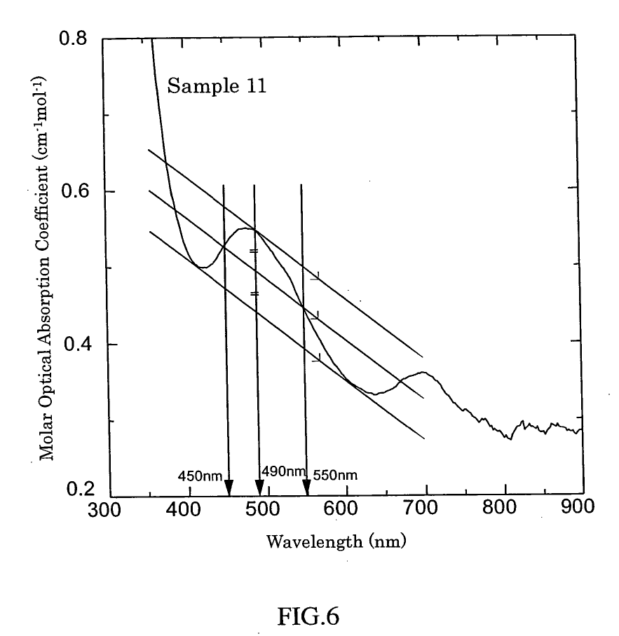

Table 1 shows the characteristics determined with respect to those glass samples. The respective glass samples were observed visually and were red or reddish brown. The light transmission spectra of all the glass samples each had an optical absorption peak in the wavelength ranges of 400 nm to 550 nm and 650 nm to 750 nm. FIG. 5 shows the light transmission spectrum of Sample 11 while FIG. 6 shows the optical absorption spectrum of Sample 11. The half-height width of the optical absorption peak at a wavelength of 490 nm shown in FIG. 6 is 100 nm. All the glass samples had an optical absorption peak whose half-height width was at least 30 nm.

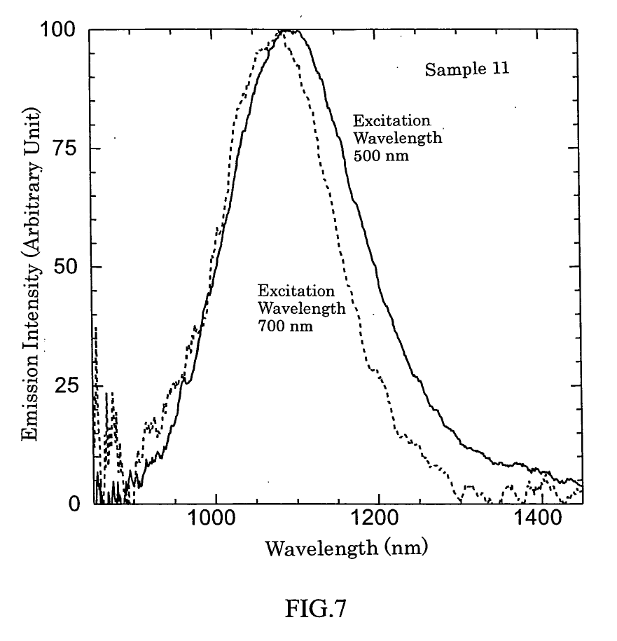

Fluorescence whose wavelength was in the infrared region was observed in all the glass samples. FIG. 7 shows fluorescence spectra of Sample 11. It can be observed that fluorescence in a wide wavelength range, specifically 900 nm to 1400 nm, was obtained through each excitation caused by irradiation of lights with wavelengths of 500 nm and 700 nm. A half-height width of fluorescence of at least 150 μm was obtained in all the glass samples including Sample 11. Furthermore, an emission lifetime (a lifetime of fluorescence) of at least 250 μs was obtained in all the glass samples.

In all the glass samples, it was observed that signal lights with wavelengths of 1064 nm and 1314 nm were amplified with excitation light having a wavelength of 532 nm. As shown in Table 1, the wavelengths at which the fluorescence peak appeared in the fluorescence spectra are in the wavelength region between 1064 nm and 1314 nm in all the glass samples. Such glass samples allow optical amplification to be carried out at least in a part of the above-mentioned wavelength region. With consideration given to fluorescence of the glass samples in a wide wavelength range, the optical amplification can be carried out over a range of at least 250 nm.

The deformation points of those glasses were not shown in Table 1 but were 750° C. or lower.

### COMPARATIVE EXAMPLE 1

Glass raw materials were prepared by the same method as in Example 1 so that the respective compositions indicated in Table 2 were obtained. Glass samples then were produced. In Sample 103, however, the batch that had been prepared was put into a platinum crucible and was kept in an electric furnace at 1450° C. for four hours. Thereafter, it was poured on an iron plate to be cooled. After this glass was kept in an electric furnace at 550° C. for 30 minutes, the power of the furnace was turned off and the glass then was cooled slowly to room temperature. Thus, the glass sample was obtained.

Using those glass samples, their characteristics were determined in the same manner as in Example 1. The results are shown in Table 2.

Samples 101 and 102 had no gloss at their surfaces and had devitrified completely to the inside thereof. Sample 103 had a common soda-lime glass composition. It, however, was transparent and colorless and had no optical absorption peak observed in the transmission spectrum thereof. Sample 103 did not emit light in the infrared region even when being irradiated with light having a wavelength in the range of 400 nm to 850 nm.

### EXAMPLE 2

### Phosphate Glass

In this example, glass compositions were obtained using three types of production methods A to C.

Production Method A (Method Including Melting After a Heat Treatment)

Ammonium dihydrogen phosphate, alumina, lithium carbonate, sodium carbonate, potassium carbonate, magnesium oxide, calcium carbonate, strontium carbonate, barium carbonate, titania, zirconia, silica, zinc oxide, bismuth trioxide, etc that were commercially available raw materials were weighed so that the respective compositions indicated in Table 3 were obtained. Thus raw material batches were prepared. Instead of the above-mentioned ammonium salt, other salts or phosphoric acid may be used as a phosphorus supply source.

As in Example 1, magnesium sulfate (MgSO₄) that was commercially available as a reagent also was used as a part of the MgO raw material in this example. In the composition containing Na₂O, sodium sulfate (Glauber's salt, Na₂SO₄) was used as a part of the Na₂O raw material. The content of the sulfate was 0.5 mol % in terms of oxides thereof.

Each batch thus prepared was put into an alumina crucible. It was placed in an electric furnace and the temperature inside thereof then was raised from room temperature to 1000° C. over four hours. It further was kept in the electric furnace at 1000° C. for four hours. This slow temperature rise is effective in preventing the alumina crucible from breaking. The carbonates and ammonium salt that are contained in the batch are decomposed during the period of the temperature rise and the subsequent heating. In this manner, when salts other than oxides have been decomposed beforehand, intense bubbling can be prevented from occurring in the melting process.

After the heat treatment, the batch that still was contained in the alumina crucible was moved into an electric furnace whose temperature was 1400° C. and then was kept for four hours to be melted. Thereafter, it was poured on an iron plate to be cooled. The glass melt that had poured thereon was solidified in about ten seconds. After this glass was kept in an electric furnace at 600° C. for 30 minutes, the power of the furnace was turned off and the glass then was cooled slowly to room temperature. Thus, glass samples were obtained.

Production Method B (Method Including: Adding a Bi-Containing Batch to a Batch Free from Heat-Treated Bi; and Melting It)

The glass raw materials used herein were the same as those used in Method A. However, the glass raw materials were divided into a first batch composed of the raw materials other than bismuth trioxide and magnesium sulfate and a second batch containing the two raw materials and were prepared so that the respective compositions indicated in Table 3 were obtained. In this method, a predetermined amount of sulfate was contained as a part of the raw materials as in Method A.

First, the first batch was heat-treated as in Method A. Next, this batch was taken out of the alumina crucible and then was mixed with the second batch. Subsequently, the mixed batch was put into an alumina crucible and then was kept at 1400° C. for four hours to be melted. Thereafter, the glass melt was poured on an iron plate to be cooled and then was cooled slowly using an electric furnace as in Method A. Thus, glass samples were obtained. This method can prevent bismuth from being reduced due to the decomposition of ammonium salt.

Production Method C (Method Including: Adding Bi to Glass Free from Bi; and Remelting It)

The same glass raw materials as those used in Method A were divided into a first batch and a second batch as in Method B to be prepared.

As in Method B, the first batch was heat-treated as above. Subsequently, this batch that still was contained in the alumina crucible was moved into an electric furnace whose temperature was 1400° C. and then was kept for two hours to be melted. Thereafter, this was poured on an iron plate to be solidified. This solid included bubbles but was colorless and transparent glass.

This glass was pulverized and the second batch was added thereto, which then was mixed well together. This was put into an alumina crucible and was kept in an electric furnace at 1400° C. for four hours to be melted. After this, the same procedure as in Method A was carried out. That is, the melt was poured on an iron plate to be cooled and then was cooled slowly using an electric furnace. Thus glass samples were obtained.

This method also can prevent bismuth from being reduced due to the decomposition of ammonium salt. Furthermore, this method makes it easier to obtain a glass having excellent homogeneity that has less bubbles, striae, and coloring unevenness.

Glass samples (Samples 21 to 28) were obtained by any one of Methods A to C. The characteristics determined with respect to these samples are indicated in Table 3. In this case, the transmittance denotes a value obtained after subtracting the Fresnel reflection loss caused at the surface of each glass sample.

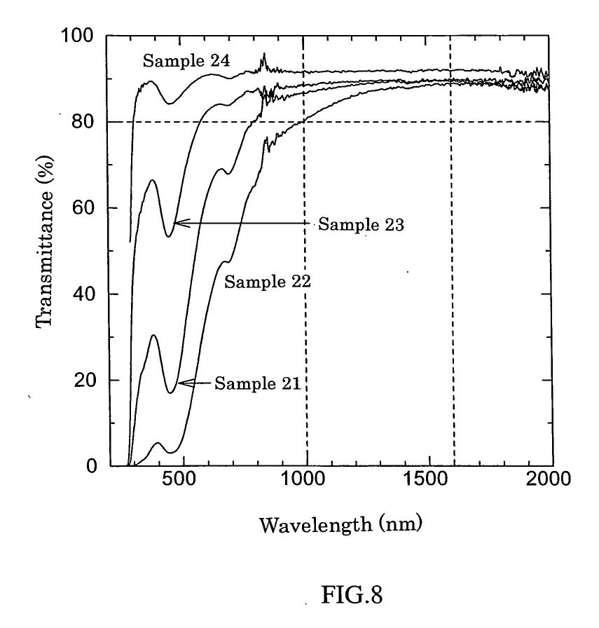

All the glass samples were observed visually and as a result, were red or reddish brown. The light transmission spectra of all the glass samples each had an optical absorption peak in the wavelength ranges of 400 nm to 550 nm and 650 nm to 750 nm. FIG. 8 shows light transmission spectra of Samples 21 to 24. Spectra indicating similar characteristics to those of Samples 21 to 24 were obtained from the other samples.

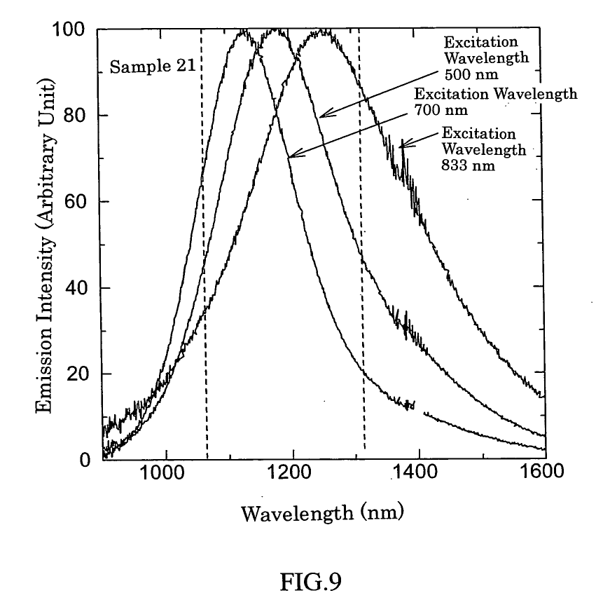

Fluorescence in the infrared region was observed in all the glass samples. FIG. 9 shows fluorescence spectra of Sample 21. In all the glass samples including Sample 21, the wavelength width of fluorescence was at least 150 μm. Furthermore, in all the glass samples, an emission lifetime (a lifetime of fluorescence) of at least 200 μs was obtained when the excitation light had a wavelength of 450 nm while an emission lifetime of at least 300 μs was obtained when the excitation light had a wavelength of 700 nm.

In all the glass samples, it was observed that signal lights with wavelengths of 1064 nm and 1314 nm were amplified with excitation light with a wavelength of 532 nm. In all the glass samples produced in Example 2, the wavelengths at which the fluorescence peaks were obtained also were in the wavelength region between 1064 nm and 1314 nm.

The optical absorption peak whose half-height width was at least 30 nm was observed in all the glass samples produced in Example 2. The deformation points were 750° C. or lower in all the glass samples.

### EXAMPLE 3

An optical fiber sample was produced and optical amplification characteristics thereof were determined. The optical fiber sample was produced so as to have a core diameter of 50 μm. In the optical fiber sample, a glass having a composition of Sample 21 was used as a core glass while a glass having a composition that was the same composition as that of Sample 24 but was free from Bi₂O₃ was used as a clad glass. The optical fiber sample was cut into a length of 10 cm so as to have sections that were specular surfaces.

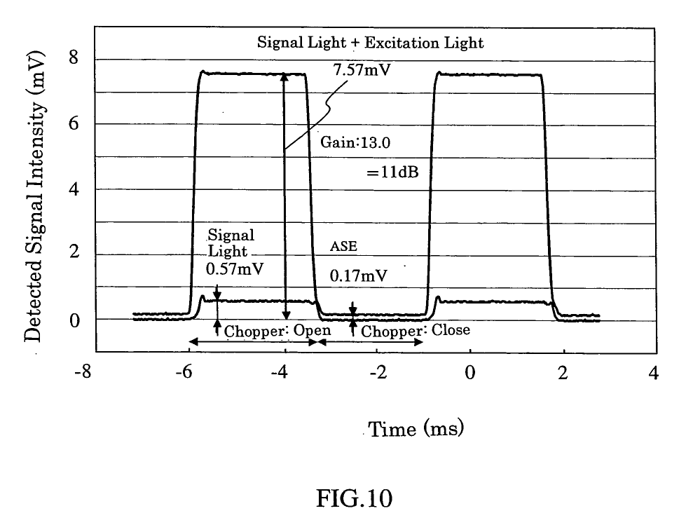

When intermittent irradiation of excitation light with a constant intensity was carried out with a chopper (omitted in FIG. 4) in a constant cycle while signal light with a wavelength of 1314 nm was allowed to enter the optical fiber sample, the intensity of the signal light increased during the irradiation of excitation light. FIG. 10 shows the results of the measurement of variations in signal light intensity that was carried out with an oscilloscope. It can be observed that an amplification gain of 13.0 times (11 dB) was obtained at a wavelength of 1314 nm.

### COMPARATIVE EXAMPLE 2

Raw materials were prepared by the same method as in Example 1 so that the respective compositions indicated in Table 4 were obtained. Glass samples then were produced.

In Comparative Example 201, however, the batch that had been prepared was put into an alumina crucible and was kept at 1750° C. for four hours. In Comparative Example 201, since it was not possible to pour the glass melt out of the crucible, the glass melt was cooled slowly while being in the crucible. Thereafter, the glass sample was cut out. The glass sample had been colored red. It, however, included numerous bubbles and striae and had an optical transmittance of only about 30% in the wavelength range of 1000 nm to 1600 nm. In Comparative Example 202, a white opaque solidified substance was obtained but only a slight part thereof had been melted. In Comparative Example 203, the melt devitrified during cooling after it was poured out.

Hereinafter, the reasons for the limitations on compositions are described with reference to the results of Examples and Comparative Examples.

Bismuth oxide is an essential element for allowing a glass composition of the present invention to emit or amplify light. A preferable bismuth oxide is a bismuth trioxide (Bi₂O₃) or a bismuth pentoxide (Bi₂O₅). An excessively low content by percentage of bismuth oxide results in an excessively low intensity of fluorescence in the infrared region that is provided by bismuth oxide. On the other hand, an excessively high content by percentage thereof results in the optical absorption peak tending not to appear in the wavelength range of 450 nm to 550 nm in a light transmission spectrum and thereby the emission intensity decreases in the infrared region. The content of bismuth oxide (in terms of Bi₂O₃) is preferably 0.01% to 5%, more preferably 0.01% to 3%, and particularly preferably 0.1% to 3%.

A preferable example of the main component of the glass network former is B₂O₃. An increase in content by percentage of B₂O₃ results in an increase in emission intensity of a glass composition but results in an increase in viscosity of a glass melt at the same time. When the content by percentage of B₂O₃ exceeds 90%, it is difficult to produce a glass composition. On the other hand, an excessive decrease in content by percentage of B₂O₃ results in a decrease in emission intensity of the glass composition in the infrared region and furthermore, allows the glass composition to tend to devitrify. When the content by percentage of B₂O₃ is less than 30%, no glass composition can be obtained. Accordingly, the content by percentage of B₂O₃ is preferably 30% to 90%, more preferably 34% to 75%, and particularly preferably 45% to 75%.

Another preferable example of the main component of the glass network former is P₂O₅. In order to prevent a glass composition from devitrifying and to obtain a homogeneous glass, the content by percentage of P₂O₅ is preferably 50% to 80%, more preferably 60% to 75%.

Al₂O₃ is an essential component for allowing bismuth oxide to emit infrared light in a glass composition. When the content by percentage thereof is less than 5%, this effect is not exhibited. On the other hand, the emission intensity of the glass composition increases with an increase in content by percentage of Al₂O₃. However, when the content by percentage thereof exceeds 30%, the solubility of glass raw materials deteriorate and the glass composition tends to devitrify even if the glass raw materials have been melted completely. Accordingly, the content by percentage of Al₂O₃ is preferably 5% to 30%, further preferably 10% to 30%, more preferably 10% to 25%, and particularly preferably 5% to 25%.

It is preferable that divalent metal oxides MO (MO=MgO+CaO+SrO+BaO+ZnO) and univalent metal oxides R₂O (R₂O=Li₂O+Na₂O+K₂O) be added to vitrify a composition. From this point of view, it is advantageous to add at least 3% of MO+R₂O. Glass is homogenized more easily with an increase in content by percentage of MO+R₂O. On the other hand, when the content by percentage of MO+R₂O exceeds 40%, devitrification becomes very likely to occur with an extremely high probability. Accordingly, the content by percentage of RO+M₂O is preferably 3% to 40%, further preferably 5% to 35%, more preferably 5% to 30%, and particularly preferably 10% to 30%.

It is advantageous that salt with high oxidizability such as sulfate (MSO₄, R₂SO₄), nitrate (M(NO₃)₂, RNO₃), etc. is used as a part of the raw materials of MO and R₂O. This is because a compound with high oxidizability is produced in a melting process and can prevent bismuth from being reduced. When the bismuth is prevented from being reduced, the container to be used for melting such as a platinum or platinum alloy crucible also can be prevented from being eroded. A preferable amount of sulfate and nitrate that is expressed in a mole ratio is at least 1/20 of bismuth oxide.

MgO is an important glass network modifier. MgO improves meltability of a raw material batch. However, an excessively high content by percentage of MgO causes a glass composition to exhibit a dark brown color, the optical absorption peak in the wavelength range of 450 nm to 550 nm to decrease, and accordingly the emission intensity to decrease rapidly. An excessively high content by percentage of MgO results in excessively low viscosity of a glass melt to cause devitrification readily. The content by percentage of MgO is preferably 0% to 40%, further preferably 0.1% to 35%, more preferably 0.1% to 30%, and particularly preferably 0.5% to 30%.

Like MgO, CaO improves the meltability of a raw material batch and is superior to MgO in characteristic of improving the devitrification resistance of glass. As in the case of MgO, however, when the content by percentage of CaO is excessively high, glass exhibits a dark brown color and thereby has a decreased emission intensity. Accordingly, the content by percentage of CaO is preferably 0% to 30%, further preferably 0% to 20%, more preferably 0% to 18%, and particularly preferably 0% to 10%.

Like MgO and CaO, SrO also improves the meltability of a raw material batch. Even a small amount (for instance, 0.1% or more) of SrO improves the devitrification resistance of glass considerably. SrO, however, has a strong effect of rapidly decreasing the intensity of fluorescence that is provided by bismuth. Accordingly, the content by percentage of SrO is preferably 0% to 15%, more preferably 0% to 5%.

Like MgO and CaO, BaO also improves the meltability of a raw material batch. BaO has a higher effect of improving the refractive index as compared to other divalent metal oxides. Since the increase in refractive index results in improvement in luster of a glass surface, the development of red or reddish brown color also is improved. Hence, it is advantageous that for instance, at least 0.1% of BaO is added. BaO, however, has a strong effect of rapidly decreasing emission intensity. Accordingly, the content by percentage of BaO is preferably 0% to 15%, more preferably 0% to 5%.

ZnO also improves the meltability of a raw material batch. ZnO has a greater effect of allowing the color of glass to develop into red or reddish brown as compared to CaO, SrO, and BaO. ZnO also is excellent in the effect of increasing the refractive index of glass as compared to MgO. With consideration given to this, a small amount (for instance, 0.1% or more) of ZnO may be added. As in the case of MgO, however, when the content by percentage of ZnO is excessively high, glass exhibits a dark brown color and thereby has a decreased emission intensity. When the content by percentage of ZnO is excessively high, glass may suffer phase separation to become cloudy and thereby transparent glass may not be obtained. Accordingly, the content by percentage of ZnO is preferably 0% to 25%, further preferably 0% to 15%, and more preferably 0% to 10%.

Li₂O is an important glass network modifier. Li₂O decreases the melting temperature to improve meltability and also improves the refractive index of glass. An addition of a suitable amount of Li₂O improves optical absorption to increase the emission intensity. It therefore is advantageous to add at least 0.1% of Li₂O. As in the case of MgO, however, when the content by percentage of Li₂O is excessively high, glass exhibits a dark brown color and thereby has a decreased emission intensity. A still higher content by percentage of Li₂O results in decreased viscosity of a glass melt and thereby devitrification tends to occur. The content by percentage of Li₂O is preferably 0% to 30%, more preferably 0% to 15%, and particularly preferably 0% to 12%.

Na₂O lowers the melting temperature as well as the liquidus temperature and thereby prevents glass from devitrifying. Na₂O, however, has a strong effect of weakening fluorescence by making the glass dark brown. Accordingly, the content by percentage of Na₂O is preferably 0% to 15%, more preferably 0% to 5%.

K₂O lowers the liquidus temperature and thereby prevents glass from devitrifying. K₂O, however, weakens fluorescence of glass in the infrared region even when a small amount thereof is added. Accordingly, the content by percentage of K₂O is preferably 0% to 5%, more preferably 0% to 2%.

TiO₂ increases the refractive index of glass and promotes fluorescence. BaO has a strong effect of decreasing the emission intensity while TiO₂ has an effect of improving the emission intensity. TiO₂, however, has an effect of making glass cloudy. Accordingly, the content by percentage of TiO₂ is preferably 0% to 10%, more preferably 0% to 5%.

Like TiO₂, ZrO₂ improves the refractive index of glass and promotes infrared fluorescence. ZrO₂, however, has an effect of accelerating crystallization of glass and increasing the density of glass. Accordingly, in order to prevent the devitrification from occurring and the density from increasing, the content by percentage of ZrO₂ is preferably 0% to 5%, more preferably 0% to 3%.

The glass composition of the present invention may include a plurality of glass network formers and may contain, for instance, SiO₂. An addition of SiO₂ provides an effect of preventing devitrification from occurring. An excessively high content by percentage of SiO₂, however, results in an excessively high viscosity of a glass melt and thereby hinders the composition from being homogenized. The content by percentage of SiO₂ is preferably 0% to 20%.

Furthermore, for the purposes of, for instance, controlling the refractive index, controlling temperature viscosity characteristics, and inhibiting devitrification, the glass compositions of the present invention may contain Y₂O₃, La₂O₃, Ta₂O₅, Nb₂O₅ and In₂O₃, preferably with the total content by percentage thereof being 5% or less, in addition to the above-mentioned components.

Moreover, for the purposes of, for instance, allowing glass to be clear when it is melted and preventing bismuth from being reduced, the glass composition of the present invention may include As₂O₃, Sb₂O₃, SO₃, SnO₂, Fe₂O₃, Cl and F, preferably with the total content by percentage thereof being 1% or less.

Components other than those described above may be introduced, as trace amounts of impurities, into glass raw materials. However, when the total content by percentage of such impurities is less than 1%, the ultimate effect on the physical properties of the glass composition is small and therefore does not cause any substantial problems.

It is not necessary for the glass compositions of the present invention to contain Nd, Er, Pr, Ni, and Cr in order to exhibit a fluorescence function or an optical amplification function. Accordingly, the glass composition may be substantially free from those elements. In this context, the expression “substantially free” denotes that the contents by percentage thereof are less than 1%, preferably less than 0.1% in terms of oxides thereof that have the highest stability in glass.

The glass compositions of the present invention can be used in the 1310-nm range and at 1064 nm. The 1310-nm range is one of the wavelength ranges that are used in optical communications mainly while 1064 nm is the emission wavelength of a Nd-YAG laser. The present invention can provide a new optical amplification medium that works in the wavelength range of 1100 nm to 1300 nm, for which no suitable optical amplification material has been reported. The glass compositions of the present invention can provide broad fluorescence spectra over 900 nm to 1400 nm in at least preferable embodiments thereof. The use of them makes it possible to provide light amplifiers that operate in that wide wavelength range.

TABLE 1

| | Sample | | | | | | | |
|---|---|---|---|---|---|---|---|---|
| | 11 | 12 | 13 | 14 | 15 | 16 | 17 | 18 |
| Composition(mol %) | | | | | | | | |
| B₂O₃ | 59.7 | 59.7 | 59.7 | 59.7 | 59.7 | 59.7 | 59.7 | 59.7 |
| Al₂O₃ | 24.9 | 22.4 | 19.9 | 24.9 | 24.9 | 24.9 | 24.9 | 24.9 |
| Li₂O | 0 | 0 | 0 | 0 | 0 | 0 | 3.0 | 0 |
| Na₂O | 0 | 0 | 0 | 0 | 0 | 0 | 0 | 1.0 |
| K₂O | 0 | 0 | 0 | 0 | 0 | 0 | 0 | 1.0 |
| MgO | 14.9 | 17.4 | 19.9 | 5.0 | 9.9 | 5.9 | 10.9 | 11.9 |
| CaO | 0 | 0 | 0 | 9.9 | 0 | 0 | 0 | 0 |
| SrO | 0 | 0 | 0 | 0 | 5 | 0 | 0 | 0 |
| BaO | 0 | 0 | 0 | 0 | 0 | 0 | 1.0 | 0 |
| TiO₂ | 0 | 0 | 0 | 0 | 0 | 1.0 | 0 | 0 |
| ZrO₂ | 0 | 0 | 0 | 0 | 0 | 0 | 0 | 1.0 |
| ZnO | 0 | 0 | 0 | 0 | 0 | 8.0 | 0 | 0 |
| Bi₂O₃ | 0.5 | 0.5 | 0.5 | 0.5 | 0.5 | 0.5 | 0.5 | 0.5 |
| MO + R₂O | 14.9 | 17.4 | 19.9 | 14.9 | 14.9 | 13.9 | 14.9 | 13.9 |
| Presence of Optical | | | | | | | | |
| Absorption Peak | | | | | | | | |
| 400 nm to 550 nm | Yes | Yes | Yes | Yes | Yes | Yes | Yes | Yes |
| 650 nm to 750 nm | Yes | Yes | Yes | Yes | Yes | Yes | Yes | Yes |
| Fluorescence Spectrum | | | | | | | | |
| obtained through Excitation | | | | | | | | |
| at 500 nm | | | | | | | | |
| Wavelength of Peak | 1096 | 1107 | 1112 | 1104 | 1109 | 1099 | 1117 | 1105 |
| Fluorescence (nm) | | | | | | | | |
| Half-Height Width of | 200 | 197 | 195 | 199 | 200 | 198 | 195 | 195 |
| Fluorescence (nm) | | | | | | | | |
| Fluorescence Spectrum | | | | | | | | |
| obtained through Excitation | | | | | | | | |
| at 700 nm | | | | | | | | |
| Wavelength of Peak | 1080 | 1087 | 1094 | 1085 | 1091 | 1082 | 1097 | 1086 |
| Fluorescence (nm) | | | | | | | | |
| Half-Height Width of | 194 | 190 | 186 | 192 | 192 | 191 | 187 | 188 |
| Fluorescence (nm) | | | | | | | | |
| Lifetime of Fluorescence | | | | | | | | |
| Excitation at 500 nm and | 304 | 295 | 288 | 270 | 285 | 284 | 291 | 283 |
| Measurement at 1140 nm | | | | | | | | |
| (μs) | | | | | | | | |
| Linear Expansion Coefficient | 60 | 66 | 68 | 65 | 62 | 65 | 64 | 65 |
| (10⁻⁷° C.) | | | | | | | | |
| Glass Transition Point (° C.) | 644 | 633 | 612 | 598 | 631 | 644 | 609 | 603 |
| Deformation Point (° C.) | 686 | 662 | 646 | 641 | 668 | 691 | 651 | 647 |

TABLE 3

| | Sample | | | | | | | |
|---|---|---|---|---|---|---|---|---|
| Composition (mol %) | 21 | 22 | 23 | 24 | 25 | 26 | 27 | 28 |
| P₂O₅ | 67.0 | 67.3 | 67.3 | 64.8 | 67.3 | 69.3 | 74.3 | 55.2 |
| Al₂O₃ | 22.3 | 22.4 | 22.4 | 19.9 | 22.4 | 16.4 | 9.7 | 19.8 |
| Li₂O | 9.9 | 0.0 | 0.0 | 0 | 0 | 5 | 8.0 | 0 |
| Na₂O | 0 | 0 | 0 | 0 | 0 | 1 | 2 | 0 |
| K₂O | 0 | 0 | 0 | 0 | 0 | 0 | 0 | 1 |
| MgO | 0.5 | 10.0 | 10.0 | 15.0 | 0.5 | 1.7 | 0.9 | 13.0 |
| CaO | 0 | 0 | 0 | 0 | 9.5 | 3 | 0 | 0.0 |
| SrO | 0 | 0 | 0 | 0 | 0 | 0 | 2 | 0.0 |
| BaO | 0 | 0 | 0 | 0 | 0 | 0 | 0 | 3.0 |
| TiO₂ | 0 | 0.0 | 0 | 0 | 0 | 2 | 0 | 0 |
| ZrO₂ | 0.0 | 0.0 | 0.0 | 0 | 0 | 1 | 0.0 | 0 |
| ZnO | 0 | 0 | 0 | 0 | 0 | 0.0 | 3 | 0 |
| SiO₂ | 0 | 0 | 0 | 0 | 0 | 0 | 0 | 5.0 |
| Bi₂O₃ | 0.3 | 0.3 | 0.3 | 0.3 | 0.3 | 0.6 | 0.1 | 3.0 |
| MO + R₂O | 10.4 | 10.0 | 10.0 | 100 | 10 | 10.7 | 15.9 | 17.0 |
| Glass Production Method | B | B | A | B | B | C | A | A |
| Presence of Optical | | | | | | | | |
| Absorption Peak | | | | | | | | |
| 450 nm to 550 nm | Yes | Yes | Yes | Yes | Yes | Yes | Yes | Yes |
| 650 nm to 750 nm | Yes | Yes | Yes | Yes | Yes | Yes | Yes | Yes |
| Transmittance of 3-mm Thick | | | | | | | | |
| Sample (%) | | | | | | | | |
| Minimum Value at 1000 nm | 89 | 87 | 80 | 89 | 92 | 85 | 80 | 82 |
| to 1600 nm | | | | | | | | |
| Fluorescence Spectrum | | | | | | | | |
| obtained through Excitation at | | | | | | | | |
| 450 nm | | | | | | | | |
| Wavelength of Peak | 1115 | 1180 | 1182 | 1115 | 1175 | 1120 | 1130 | 1140 |
| Fluorescence (nm) | | | | | | | | |
| Half-Height Width of | 236 | 237 | 258 | 236 | 230 | 220 | 240 | 230 |
| Fluorescence (nm) | | | | | | | | |
| Fluorescence Spectrum | | | | | | | | |
| obtained through Excitation at | | | | | | | | |
| 700 nm | | | | | | | | |
| Wavelength of Peak | 1122 | 1132 | 1132 | 1122 | 1130 | 1120 | 1130 | 1120 |
| Fluorescence (nm) | | | | | | | | |
| Half-Height Width of | 177 | 189 | 198 | 177 | 170 | 180 | 170 | 180 |
| Fluorescence (nm) | | | | | | | | |
| Fluorescence Spectrum | | | | | | | | |
| obtained through Excitation at | | | | | | | | |
| 833 nm | | | | | | | | |
| Wavelength of Peak | 1204 | 1253 | 1263 | 1204 | 1250 | 1240 | 1250 | 1240 |
| Fluorescence (nm) | | | | | | | | |
| Half-Height Width of | 332 | 323 | 306 | 332 | 300 | 310 | 300 | 310 |
| Fluorescence (nm) | | | | | | | | |
| Lifetime of Fluorescence (μs) | | | | | | | | |
| Excitation at 450 nm and | 320 | 343 | 289 | 320 | 310 | 295 | 275 | 290 |
| Measurement at 1140 nm | | | | | | | | |
| Excitation at 700 nm and | 487 | 493 | 408 | 487 | 450 | 430 | 410 | 420 |
| Measurement at 1120 nm | | | | | | | | |
| Excitation at 833 nm and | 167 | 158 | 142 | 167 | 160 | 150 | 140 | 160 |
| Measurement at 1250 nm | | | | | | | | |
| Refractive Index | 1.520 | 1.504 | 1.513 | 1.506 | 1.514 | 1.518 | 1.512 | 1.519 |
| Abbe Number | 65 | 71 | 87 | 65 | 70 | 66 | 68 | 69 |
| Linear Expansion Coefficient | 66 | 55 | 56 | 62 | 63 | 68 | 63 | 60 |
| (10⁻⁷ ° C.) | | | | | | | | |
| Glass Transition Point (° C.) | 528 | 646 | 648 | 605 | 663 | 595 | 638 | 643 |
| Deformation Point (° C.) | 584 | 703 | 702 | 659 | 708 | 649 | 692 | 688 |

TABLE 2

| | Sample | | |
|---|---|---|---|
| Composition(mol %) | 101 | 102 | 103 |
| SiO₂ | 0 | 0 | 70.4 |
| B₂O₃ | 24.8 | 44.9 | 0 |
| Al₂O₃ | 29.8 | 34.9 | 2.3 |
| Li₂O | 44.6 | 10.0 | 0 |
| Na₂O | 0 | 0 | 13 |
| K₂O | 0 | 0 | 0 |
| MgO | 0.5 | 10.0 | 6 |
| CaO | 0 | 0 | 8 |
| SrO | 0 | 0 | 0 |
| BaO | 0 | 0 | 0 |
| TiO₂ | 0 | 0 | 0 |
| ZrO₂ | 0 | 0 | 0 |
| Bi₂O₃ | 0.3 | 0.3 | 0.3 |
| Glass | Devitrified | Devitrified | Vitrified |
| Color Tone of Glass | — | — | Colorless and |
| | | | Transparent |
| Optical Absorption Peak | — | — | None |

TABLE 4

| | Sample | | |
|---|---|---|---|
| Composition(mol %) | 201 | 202 | 203 |
| P₂O₅ | 0 | 54.9 | 51.8 |
| Al₂O₃ | 2.2 | 44.8 | 2.0 |
| Li₂O | 0 | 0 | 0 |
| Na₂O | 0 | 0 | 0 |
| K₂O | 0 | 0 | 0 |
| MgO | 0 | 0 | 45.9 |
| CaO | 0 | 0 | 0 |
| SrO | 0 | 0 | 0 |
| BaO | 0 | 0 | 0 |
| TiO₂ | 0 | 0 | 0 |
| ZrO₂ | 0 | 0 | 0 |
| ZnO | 0 | 0 | 0 |
| SiO2 | 97.5 | 0 | 0 |
| Bi₂O₃ | 0.3 | 0.3 | 0.3 |
| MO + R₂O | 0 | 0 | 45.9 |
| State of Glass | Vitrified | Not | Devitrified |
| | | Meltable | |
| Color Tone of Glass | Red | White | Dark Brown |
| Optical Absorption Peak | | | |
| 400 nm to 550 nm | Present | — | — |
| 657 nm to 750 nm | Present | — | — |
| Transmittance of 3-mm | 30 | — | — |
| Thick Sample (%) | | | |
| Minimum Value | | | |
| at 1000 nm to 1600 nm | | | |

1. A glass composition comprising:
a bismuth oxide;
an aluminum oxide; and
a glass network former,
wherein the glass network former includes an oxide other than a silicon oxide as its main component, and the glass composition emits fluorescence in an infrared wavelength region through irradiation of excitation light, with bismuth contained in the bismuth oxide functioning as a fluorescent source.

2. The glass composition according to claim 1, wherein the main component of the glass network former is a phosphorus pentoxide, a boron oxide, a germanium oxide, or a tellurium dioxide.

3. The glass composition according to claim 1, having an optical absorption peak in a wavelength range of 400 nm to 900 nm.

4. The glass composition according to claim 1, wherein a wavelength at which the maximum intensity of the fluorescence that is emitted through the irradiation of excitation light having a wavelength in a range of 400 nm to 900 nm is obtained is in a range of 900 nm to 1600 nm.

5. The glass composition according to claim 4, wherein a half-height width with respect to the wavelength of the fluorescence is at least 150 nm.

6. The glass composition according to claim 1, providing a gain in signal light amplification in at least a part of a wavelength range of 900 nm to 1600 nm through the irradiation of excitation light.

7. The glass composition according to claim 1, further comprising a univalent or divalent metal oxide.

8. The glass composition according to claim 7, wherein the divalent metal oxide is at least one selected from the group consisting of MgO, CaO, SrO, BaO, and ZnO.

9. The glass composition according to claim 7, wherein the univalent metal oxide is at least one selected from the group consisting of Li₂O, Na₂O, and K₂O.

10. The glass composition according to claim 7, wherein the content of the metal oxide that is univalent or divalent is in a range of 3 mol % to 40 mol %.

11. The glass composition according to claim 1, wherein the content of the bismuth oxide is in a range of 0.01 mol % to 15 mol % in terms of Bi₂O₃.

12. The glass composition according to claim 11, wherein the content of the bismuth oxide is in a range of 0.01 mol % to 5 mol % in terms of Bi₂O₃.

13. The glass composition according to claim 1, wherein the content of the aluminum oxide is in a range of 5 mol % to 30 mol %.

14. The glass composition according to claim 1, wherein the content of the main component of the glass network former is in a range of 30 mol % to 90 mol %.

15. The glass composition according to claim 2, comprising the following components, indicated by mol %:
30 to 90 B₂O₃;
5 to 30 Al₂O₃;
0 to 30 Li₂O;
0 to 15 Na₂O;
0 to 5 K₂O;
0 to 40 MgO;
0 to 30 CaO;
0 to 5 SrO;
0 to 5 BaO;
0 to 25 ZnO;
0 to 10 TiO₂; and
0 to 5 ZrO₂,
wherein the total of MgO+CaO+SrO+BaO+ZnO+Li₂O+Na₂O+K₂O is in a range of 3 mol % to 40 mol %, and
the content of the bismuth oxide is in a range of 0.01 mol % to 15 mol % in terms of Bi₂O₃.

16. The glass composition according to claim 2, comprising the following components, indicated by mol %:
50 to 80 P₂O₅;
5 to 30 Al₂O₃;
0 to 30 Li₂O;
0 to 15 Na₂O;
0 to 5 K₂O;
0 to 40 MgO;
0 to 30 CaO;
0 to 15 SrO;
0 to 15 BaO;
0 to 15 ZnO;
0 to 10 TiO₂;
0 to 5 ZrO₂; and
0 to 20 SiO₂,
wherein the total of MgO+CaO+SrO+BaO+ZnO+Li₂O+Na₂O+K₂O is in a range of 3 mol % to 40 mol %, and
the content of the bismuth oxide is in a range of 0.01 mol % to 15 mol % in terms of Bi₂O₃.

17. An optical fiber comprising a glass composition according to claim 1.

18. A light amplifier comprising a glass composition according to claim 1.

19. A method of manufacturing a glass composition according to claim 1, comprising:
melting a raw material of the glass composition; and
cooling the raw material that has been melted,
wherein the method further comprises, before melting the raw material, a heat treatment step in which a first material that contains ammonium salt and that is at least a part of the raw material is maintained at a temperature at which at least the ammonium salt decomposes.

20. The method of manufacturing a glass composition according to claim 19, further comprising, after the heat treatment step but before the melting step, a step of mixing the first material with a second material that includes a raw material of bismuth oxide or a bismuth oxide.

21. A method of amplifying signal light by allowing excitation light and signal light to enter a glass composition according to claim 1 to amplify the signal light.
